(19) United States
(12) Patent Application Publication
(10) Pub. No.: US 2011/0055083 A1
(43) Pub. Date: Mar. 3, 2011

(54) System and method of funds transfer using a secure financial account

(76) Inventor: Mordechai S. Grinhute, Vancouver (CA)

(21) Appl. No.: 12/584,036

(22) Filed: Aug. 31, 2009

(51) Int. Cl. G06Q 40/00

(52) U.S. Cl. 705/42; 705/39

(57) ABSTRACT

A system and method of transferring funds from a depositor (payer) to a recipient (payee) comprises at least one account issuer issuing a deposit account located at a first financial institution and a withdraw account located at a second financial institution. A first reserve account is established at the first financial institution and a second reserve account is established at the second financial institution. An online processing system automatically detects when funds are deposited into the deposit account and automatically transfers the funds from the deposit account to the first reserve account. The funds from the first reserve account are transferred to the second reserve account, accounting for any foreign currency exchange rates. The system electronically processes a request from the recipient to transfer at least a portion of the funds located at the second reserve account to the recipient.

### TECHNICAL FIELD

The present invention relates generally to the field of electronic transfer of funds, and, more specifically, to a system and method for transferring funds from a depositor to a recipient using secure bank accounts. The present invention also relates to a system and method of issuing and monitoring of secure bank accounts.

### BACKGROUND

There are multiple options to transfer money between two people in different countries including bank transfer services, courier companies, prepaid cards as well as agent based money transfer companies such as Western Union and MoneyGram.

Each of these services has drawbacks. For example a bank transfer service requires both the depositor and the recipient to have existing bank accounts. Conventional bank checking and savings accounts are often not available to minors, persons with poor credit or financial status, travelers in foreign countries, or countries with repressive regimes. Even if those persons have a bank account, generally they will have to visit the financial institution in person at inconvenient times to receive cash. Further traditional bank accounts allow for deposits and withdraw, thus identity theft and fraud are concerns when that account information is disseminated.

Courier companies and agent based money transfer services suffer from human error in the handling of the funds and unscrupulous use of sensitive financial information. Agent based money transfer services require a sender to go to the agent's facility, complete cumbersome paperwork, have money transferred to a site near the recipient, who then must go to the transfer agent's site to receive the cash. The recipient then needs to provide identification, fills in more paperwork to ensure the accuracy and legitimacy of the recipient. This is a slow and often inconvenient arrangement. Prepaid cards require purchase from a dedicated retail store, which may not be available in rural areas.

Furthermore, providing credit/debit information for online transactions to a stranger (i.e. eBay buyer) renders one vulnerable to identity theft and fraud. There are payment options via electronic or computer devices such as cell phones and PDAs, in which the customer's credit/debit account information is transferred to payee via wireless signal. However these signals can be intercepted for purposes of theft and fraud by the interceptor. Thus, the systems and methods available today do not provide a convenient and safe mechanism for transferring funds between a depositor and recipient.

### SUMMARY OF INVENTION

As used in the following embodiments, a deposit account generally refers to a deposit bank account, a deposit card account or a deposit account identification number (“ID”). The deposit account is adapted for allowing a customer to make a deposit of funds and serves as the origination account. The deposit account allows for deposit only. A withdraw account generally refers to a withdraw bank account, a withdraw card account, a withdraw account ID, or a checking account. The withdraw account is adapted for allowing a customer to make withdraws and payments and serves as the destination account.

In general, in a first aspect, the invention features a method of electronically processing and transferring funds from a depositor (payer) to a recipient (payee). Paired bank accounts with associated account access cards or paired cards account (“CA”) are issued to a customer, generally the depositor or recipient: a first bank account/CA is for deposits and a second bank account/CA is for withdraw.

The cards, such as access cards and CAs, can have an account ID, card ID and personal identification number (“PIN”) for security purposes similar to a traditional credit/debit card. The deposit bank account/CA allows for deposits only. The withdraw bank account functions as a debit account, a checking account or a prepaid credit account. The withdraw CA functions as a prepaid credit/debit card.

In one embodiment the deposit bank account/CA is issued in a first currency, usually a domestic currency of the origination country. The withdraw bank account/CA is issued in a second currency, usually a foreign currency of the destination country.

In another embodiment, a single secure account is issued to a customer. The single secure account has a deposit account ID, a withdraw account ID and a first and a second access card for each account ID respectively. The deposit account ID and its access card allow for deposits only. The withdraw account ID and its access card functions as a debit account, a checking account or as a prepaid credit account.

In a second aspect, the invention features a system which electronically processes and transfers funds from the deposit account to the withdraw account. The deposit account and the withdraw account are therefore linked. The online processing system monitors and automatically identifies when deposits are made to the deposit account and automatically credits the available funds to the withdraw account. The online processing system accounts for foreign currency exchange rates.

Generally, in one aspect the depositor sends to the recipient the withdraw access card, with the PIN, or the recipient sends the deposit access card and the PIN to the depositor. In another aspect, the recipient (typically a business or vendor) provides the deposit card or deposit account ID to the depositor (typically a buyer of goods or services). The depositor deposits funds into the deposit account through any suitable manner, such as ATM, live teller, or online banking services. The system automatically credits the withdraw account based on the funds available in the deposit account, while accounting for any foreign currency exchange rates and applicable fees. The recipient uses the withdraw card to make purchases or withdraw funds similar to a pre paid credit card or a debit card. In still a further aspect, a withdraw bank account/withdraw account ID can be used as a checking account.

### BRIEF DESCRIPTION OF THE DRAWINGS

FIG. 1 is a schematic diagram showing a system and method of issuing secure bank accounts.

FIG. 2 is a schematic diagram showing a system and method of issuing another of secure bank accounts.

FIG. 3 is a schematic diagram showing a system of transferring funds from a depositor to a recipient.

FIG. 4 is a block diagram showing the components of a financial processing system.

FIG. 5 is a diagram showing the interactions of a system and method of transferring funds from a depositor to a recipient.

FIG. 6 is a diagram showing a further embodiment of a system and method of transferring funds from a depositor to a recipient.

FIG. 7 is a block diagram of the components of a computer as used in accordance with the invention.

### DETAILED DESCRIPTION

### Payment Processor

Typically, a payment processor processes financial transactions, including credit, debit, deposits, payments, and withdraws on behalf of one or more financial institution such as banks. Generally a payment processor also has the capability to issue accounts on behalf of issuer banks. Payment processors are usually a third party but can also be part of a bank.

Paired Bank Accounts

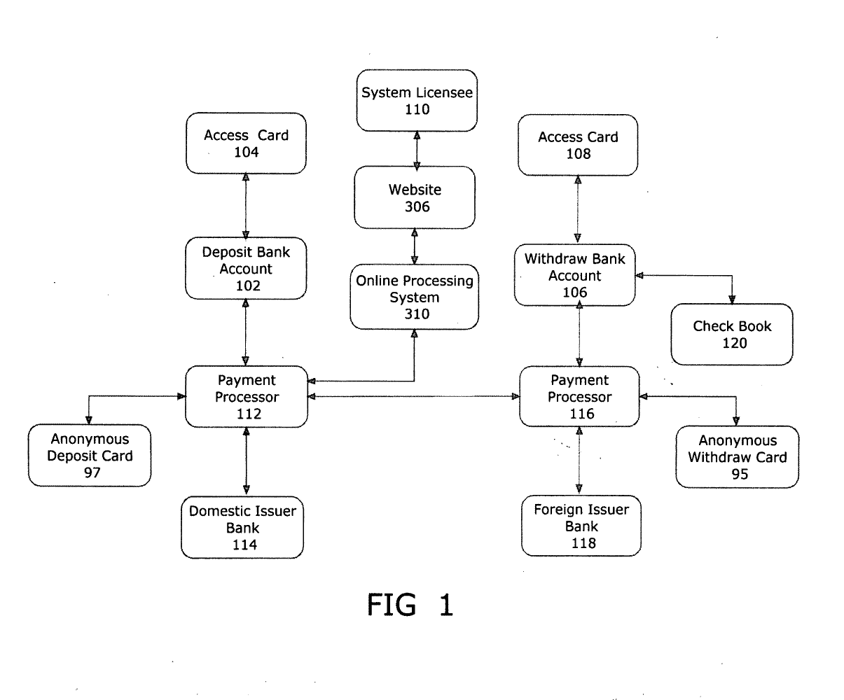

Referring to FIG. 1, two bank accounts are issued to a customer, generally the depositor, but the recipient can also establish the accounts. The bank accounts are generally issued by a system licensee 110 (“SL 110”) operating through payment processors 112 (“PP 112”) and PP 116 and approved by issuer banks. A deposit bank account 102 (“DBA 102”) is issued in the origination country by a domestic issuer bank 114 (“DIB 114”). This account is capable of deposits only. Withdraws from this account cannot be made. A withdraw banking account 106 (“WBA 106”) is issued in the destination country, typically a foreign country with a foreign currency by a foreign issuer bank 118 (“FIB 118”). These accounts are paired or linked which means that the accounts are in communication with each other, capable of electronically transferring funds from DBA 102 at a first location to WBA 106 at a second location. The WBA 106 can also be issued in a domestic currency. In one aspect, DBA 102 and DIB 114 have account identification numbers (“ID”s) capable of being recognized by payment processors and financial networks. In another aspect DBA 102 and DIB 114 have online account IDs enabling a customer to access the accounts via online or internet banking services. The SL 110 operates the online processing system 310, through, in one embodiment, website 306 as discussed in more detail below. The OPS 310 is connected to PP 112 and PP 116 as discussed in more detail below.

Paired Card Accounts

In another embodiment, referring to FIG. 1, two anonymous card accounts are issued to an anonymous customer, generally the depositor, but the recipient can also obtain the card accounts. The anonymous card accounts are generally issued in same manner as the paired bank accounts above. One card is for deposits only, referred to as anonymous deposit card 97 (“ADC 97”) which is generally issued in a domestic currency. The second card, anonymous withdraw card 95 (“AWC 95”) is a prepaid credit/debit card generally issued in a foreign currency. The AWC 95 can also be issued in a domestic currency. In one aspect, ADC 97 and AWC 95 have account IDs capable of being recognized by payment processors and financial networks. In another aspect ADC 97 and AWC 95 have online account IDs enabling a customer to access the accounts via online or internet banking services.

The ADC 97 and AWC 95 are paired or linked which means that the accounts are in communication with each other, capable of electronically transferring funds from ADC 97 at a first location to AWC 95 at a second location. In one aspect, ADC 97 and AWC 95 have card ID(s) and personal identification number(s) (“PIN”s). Generally the two accounts are issued without requiring personal information from the customer. The ADC 97 and AWC 95 are issued active and ready for use. In one aspect, the ADC 97 has a funds transfer restriction such as on the amount of funds that can be transferred per week, i.e., $300 per week. Generally transfer restrictions are dictated by local government regulations.

Paired Account IDs

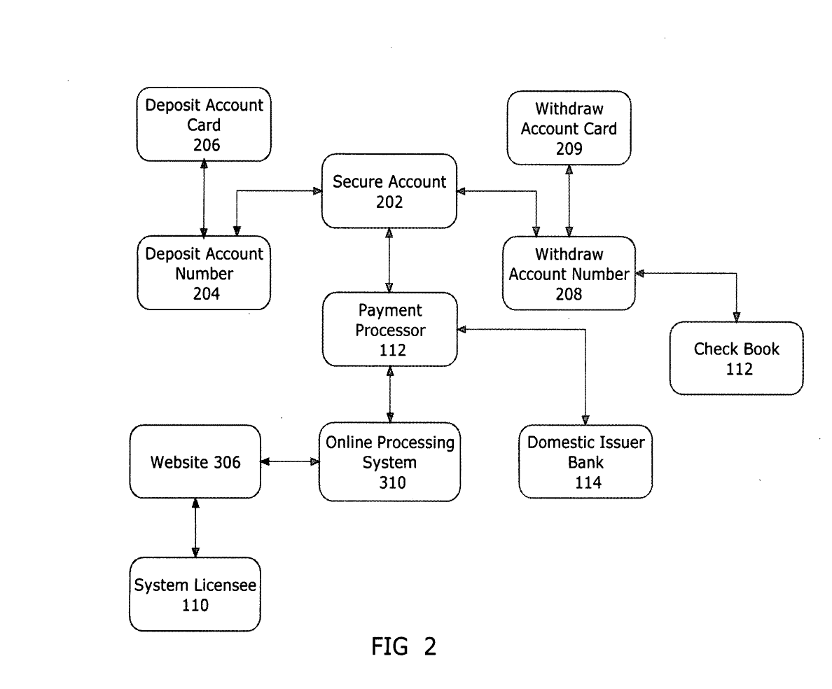

In another embodiment, as depicted in FIG. 2, a secure account 202 (“SA 202”) is issued to a customer by SL 110 in a similar manner as DBA 102 and WBA 106. SA 202 has two account IDs which allow a single account to have deposit and withdraw capabilities. A first account ID is for deposits only, referred to as deposit account number 204 (“DAN 204”). A second account ID is for withdraw or payments, i.e. a debit account, checking account, or a prepaid credit account, referred to as withdraw account number 208 (“WAN 208”). The deposit account ID allows for deposits only. In one aspect, DAN 204 and WAN 208 have account IDs capable of being recognized by payment processors and financial networks. In another aspect DAN 204 and WAN 208 have online account IDs enabling a customer to access the accounts via online or internet banking services.

Cards

The embodiments contained in the description have cards used to provide access to the deposit and withdraw accounts. The cards are generally similar to a credit or debit card, having a unique serial number, a magnetizable strip or computer chip that stores information necessary to complete a financial transaction such as cardholder account information, issuer bank identification number, etc. The card could also be a computer device such as a cell phone or PDA. The card enables the cardholder to access the account and perform transactions via ATM, bank teller, Point Of Sell (“POS”) terminal and online interfaces.

Referring to FIG. 1, in one aspect, an access card 104, (“AC 104”) is used to access DBA 102. An access card 108 (“AC 108”) is used to access WBA 106. Multiple access cards can be issued for each DBA 102, or WBA 106. Each card has a unique PIN and a card ID.

Still referring to FIG. 1, in a further aspect, ADC 97 and AWC 95 are deposit and withdraw accounts issued as cards. Because AC 104, or ADC 97 is for deposits only the loss of the card and/or disclosure of related PIN does not allow fraudulent withdraw from the account.

In still another aspect, multiple AC 104 are distributed to a plurality of depositors each with a unique PIN and/or unique ID registered to one DBA 102. For example a loan company can seek collection from a plurality of debtors who deposit funds to a single DBA 102. The company via website 306 can recognize the depositor according to the ID/PIN used to deposit the funds and the debtors can use the deposit receipt as proof of payment. In another embodiment an employer with a plurality of employees is the depositor with a DBA 102 and a WBA 106. Multiple AC 108, each with a unique PIN and/or unique ID, are distributed to the employees. The employer can transfer funds from DBA 102 to WBA 106. Each employee can use an AC 108 to pay for business expenses.

In still a further aspect, AC 108 and AWC 95 can be used at any ATM, vendor, retailer, etc, that accepts credit/debit cards. The AC 104 and ADC 97 can be used at any ATM and financial intuition that accepts deposit for other financial institutions.

Transactions of such accounts are communicated to one or more financial networks as discussed in more detail below. Thus deposits, withdraw and payments can be made at retail banks such as Royal Bank of Canada, Bank of America, etc.

Referring to FIG. 2, in a further embodiment, pertaining to SA 202, a first account card is associated with DAN 204, referred to as deposit account card 206 (“DAC 206”). A second account card is associated with the WAN 208 referred to as withdraw access card (“WAC 209”). Each access card has a unique PIN. The PIN of WAC 209 should remain confidential. The account IDs and PIN of DAC 206 and DAN 204 can be disclosed without concern of fraud since they are for deposits only. In one aspect, SA 202 can be accessed using DAN 204, DAC 206, WAC 208 or WAN 209. In another aspect, multiple DAC 206, or multiple WAN 209 can be issued for a single SA 202—each card would have a unique ID and PIN.

Referring to FIG. 1 and FIG. 2, in still a further aspect, WAN 208 and WBA 106 have checking account capabilities. A check book 212 or check book 120 can be issued for the WAN 208 and WBA 106 respectively. In this aspect, WAN 208 and WBA 106 function as checking accounts and have checking account IDs. In another aspect, DBA 104 and DAN 204 functions as checking accounts and have checking account IDs but only for the purposes of making deposits.

Method of Transfer and OPS

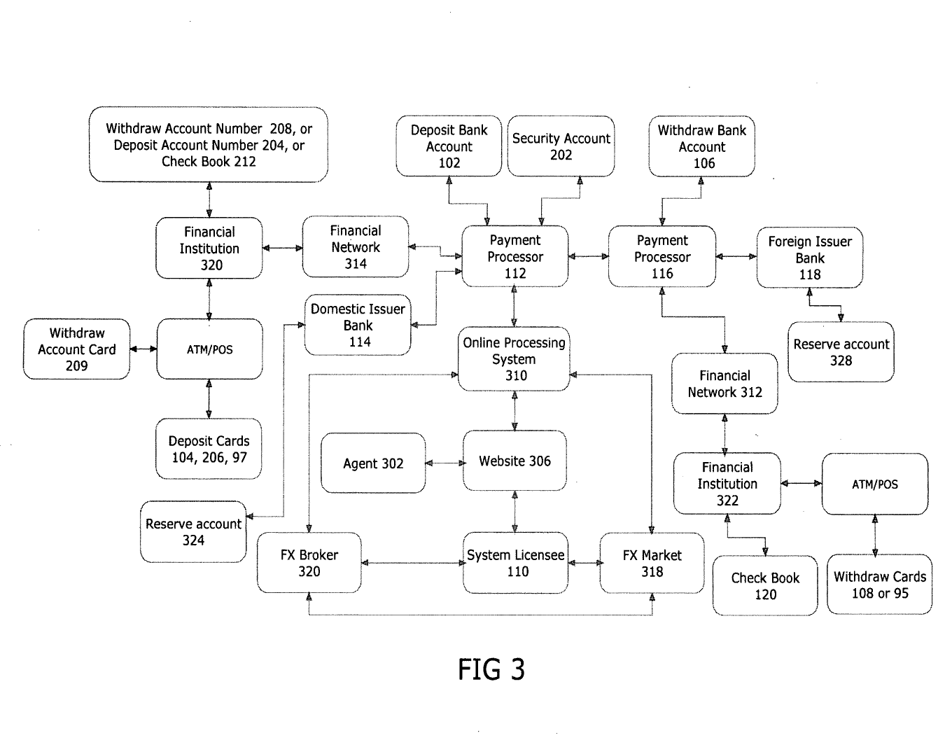

In a further aspect, referring to FIG. 3, to link or electronically process and transfer funds from a deposit account to a withdraw account, (i.e. DBA 102 to WBA 106, and ADC 97 to AWC 95), an online processing system 310 (“OPS 310”) accesses one or more financial network via a payment processor. In one embodiment OPS 310 accesses financial network 314 and 312 via PP 112 and 116 respectively. The financial network can be for example, a debit network, a credit card network, ATM network, SWIFT network, an ACH network, EFT network, a wire transfer network, and etc.

Still referring to FIG. 3, typically DIB 114 is connected to a PP 112, while FIB 118 is connected to a PP 116. The OPS 310 is a system that processes various financial transactions on behalf of a SL 110. The OPS 310 is not necessarily associated with any financial institution. To access the financial network the OPS 310 communicates with the PP 112 which in turn communicates with the financial networks 314 and 312.

System Licensee, Reserve Account and Agent

Referring to FIG. 3, the SL 110 operates the OPS 310. The SL 110 interfaces with the OPS 310 via a variety of communications links including phone, fax, email, website and computer. In one aspect, SL 110 has a website 306 (“Website 306”) which interfaces with the OPS 310. Website 306 also allows a customer and/or agent to access and monitor the accounts.

The SL 110 has agreements with one or more issuer banks, such as DIB 114 and FIB 118, to establish deposit and withdraw accounts as described above. SL 110 also has the capability to issue access cards that are associated with such accounts. In a further aspect SL 110 offers a website 306 to provide online banking services to its customers and/or agents.

Referring again to FIG. 3, SL 110 has agreements with DIB 114 and FIB 118 to establish reserve accounts associated with the deposit and withdraw accounts respectively. Generally funds in the deposit account are transferred to reserve account 324. After any applicable foreign currency exchange conversion, the funds are then transferred to a reserve account 328. In one aspect, the funds in the reserve account 328 is security for the line of credit extended to SL 110 by FIB 118 to cover payments made from the withdraw account.

Still referring to FIG. 3, in one aspect, on a daily basis or some other suitable time period, SL 110 exchanges currencies of the reserve account 324 via the FX broker 320, who deposits the converted amount to the reserve account 328 to cover any credit limits established for the withdraw accounts. This aspect is discussed in more detail below. Authorized deductions from the withdraw accounts and related settlement request are charged against the reserve account 328.

Typically an Agent 302 works for the SL 110, an issuer bank (i.e. DIB 114), or is independent. Typically a customer meets with an Agent 302 at a retail location. Agents 302 activates SL 110 issued deposit and withdraw accounts by obtaining customer information and other information, such as compliance information, that may be required by the local government regulations and transfers such information to the OPS 310, via a variety of communications links including phone, fax, email, website etc.

Customer information is not required for ADC 97 and AWC 95. The seller of ADC 97 and AWC 95, typically retail store or Agent 302, generally has an agreement with SL 110 to sell the cards and is bound to any government restrictions.

Foreign Currency Exchange

Still referring to FIG. 3, in a further aspect when the transfer of funds occurs between two countries, i.e. DBA 102 in Canada and WBA 106 in Mexico, a foreign currency exchange is initiated. The SL 110 or a foreign exchange broker 320 (“FX broker 320”) provides the current exchange rate to the OPS 310. The OPS 310 can also obtain the current exchange rate directly from the foreign currency exchange market 318 (“FX market 318”). The foreign currency exchange rate is determined by the FX market 318. In another aspect, the SL 110 can set a formula for the profit margins to account for foreign currency exchange fluctuation risk.

Modular Components of the OPS System

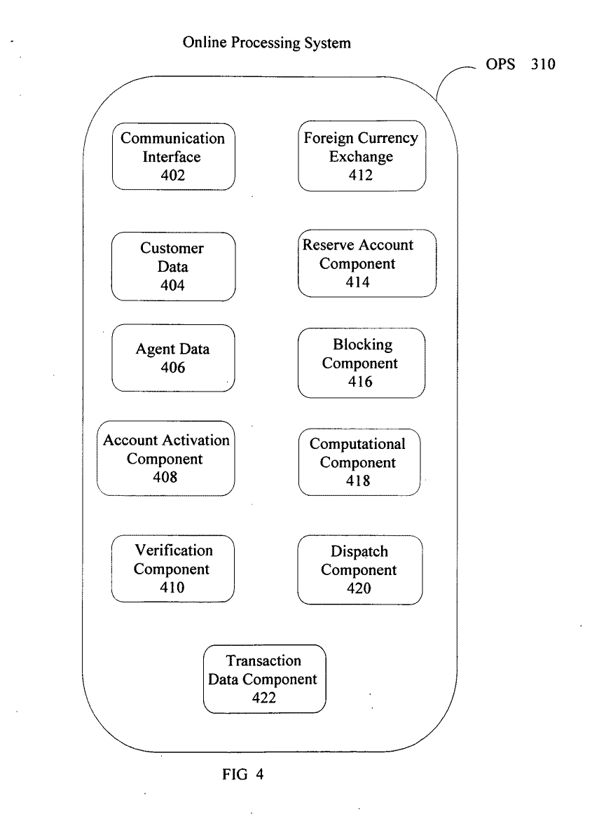

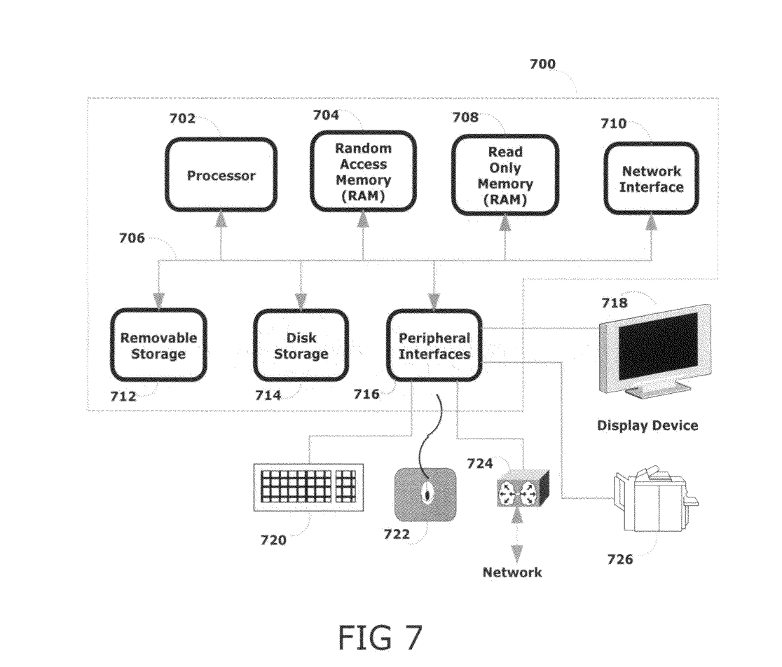

In a further aspect, a system comprises an Online Processing System 310 (“OPS 310”) which is a software program with a plurality of components and modules as depicted in FIG. 4. In one embodiment, as depicted in FIG. 7, OPS 310 runs on a computer 700. Computer 700 includes at least one processor 702 coupled to a bus 706 that couples together various system components. Bus 706 represents one or more of any of several types of bus structures, such as a memory bus or memory controller, a peripheral bus, and a processor or local bus using any of a variety of bus architectures. A random access memory (“RAM”) 704 and a read only memory (“ROM”) 706 are coupled to bus 706. Additionally, a network interface 710 and a removable storage device 712, such as a floppy disk or a CD-ROM, are coupled to bus 706. Network interface 710 provides an interface to a data communication network such as a local area network (LAN) or a wide area network (WAN) for exchanging data with other computers and devices. A disk storage 714, such as a hard disk, is coupled to bus 706 and provides for the non-volatile storage of data (e.g., computer-readable instructions, data structures, program modules and other data used by computer 700). Although computer 700 illustrates a removable storage 712 and a disk storage 714, it will be appreciated that other types of computer-readable media which can store data that is accessible by a computer, such as magnetic cassettes, flash memory cards, digital video disks, and the like, may also be used in the exemplary computer.

Various peripheral interfaces 716 are coupled to bus 706 and provide an interface between the computer 700 and the individual peripheral devices. Exemplary peripheral devices include a display device 718, a keyboard 720, a mouse 722, a modem 724, and a printer 726. Modem 724 can be used to access other computer systems and devices directly or by connecting to a data communication network such as the Internet.

A variety of program modules can be stored on the disk storage 714, removable storage 712, RAM 704, or ROM 708, including an operating system, one or more application programs, and other program modules and program data. A user can enter commands and other information into computer 700 using the keyboard 720, mouse 722, or other input devices (not shown). Other input devices may include a microphone, joystick, game pad, scanner, satellite dish, or the like.

Computer 700 may operate in a network environment using logical connections to other remote computers. The remote computers may be personal computers, servers, routers, or peer devices. In a networked environment, some or all of the program modules executed by computer 700 may be retrieved from another computing device coupled to the network.

Typically, the computer 700 is programmed using instructions stored at different times in the various computer-readable media of the computer. Programs and operating systems are often distributed, for example, on floppy disks or CD-ROMs. The programs are installed from the distribution media into a storage device within the computer 700. When a program is executed, the program is at least partially loaded into the computer's primary electronic memory. As described herein, the invention includes these and other types of computer-readable media when the media contains instructions or programs for implementing the steps described below in conjunction with a processor. The invention also includes the computer itself when programmed according to the procedures and techniques described herein.

For purposes of illustration, programs and other executable program components are illustrated herein as discrete blocks, although it is understood that such programs and components reside at various times in different storage components of the computer, and are executed by the computer's processor. Alternatively, the systems and procedures described herein can be implemented in hardware or a combination of hardware, software, and/or firmware. For example, one or more application specific integrated circuits (ASICs) can be programmed to carry out the systems and procedures described herein.

Referring to FIG. 4, a communication interface 402 allows the OPS 310 to communicate with other computing systems, such as servers, client computers, and portable computing devices. In one embodiment, communication interface 402 is a network interface to a LAN, which is coupled to another data communication network, such as the Internet.

The OPS 310's customer data 404 component stores customer information such as account and card information for both deposit accounts/cards and withdraw accounts/cards. The information includes the issuer/bank identification number (“IIN”) or (“BIN”), account ID, account currency depositor/recipient personal information, card IDs, online account ID and card PINs.

The OPS 310 stores agent data 406 such as personal information, bank account ID, fee schedule, commission schedule, etc. The OPS 310 has an account activation component 408 which receives information about a customer including personal information, purpose and type of transfer, various contractual obligations (terms and conditions), restrictions and compliance information as required by local regulations etc. This information is received by the Agent 302 and submitted to the OPS 310 via website 306 or directly by the customer via website 306.

The OPS 310 has a verification component 410 which receives the transaction detail from the financial network via a payment processor regarding any activity of all accounts, i.e. DBA 102, SA 202 and ADC 97, and the associated or paired accounts. Verification component 410 determines the mechanism of deposit and when such funds are available for withdraw. The mechanism of deposit limits when funds are available for transfer, i.e. by ATM, check, cash/credit, live teller at a financial institution. If the mechanism of deposit is cash/credit via a live teller then verification component 410 routes that information for processing and an instruction setting a credit limit is dispatched to WBA 106 or WAC 95 immediately. In the case of a SA 202 transaction, the available funds in DAN 204 are transferred to WAN 208 immediately. In a further aspect, fees for processing may be deducted from the deposit accounts.

When the verification component 410 determines that the method of deposit is not a cash or credit deposit via a live teller, component 410 scans the deposit account such as DBA 102, i.e., once a day, every hour or every one minute, until the funds are available for withdraw, if at all (i.e. a bad check). The verification component 410 checks the account activation component 408 for any transfer restrictions and other applicable limitations. Verification component 410 updates OPS 310 with the bank authorized deposit amount or cancels the transaction.

The OPS 310 has a foreign currency exchange component 412 which obtains and stores current foreign currency exchange rates for any applicable transaction, i.e. those involving transfers between two countries.

Referring to FIG. 3 and FIG. 4, the OPS 310 has a reserve account component 414 which receives information from the verification component 410 regarding whether the deposited funds of DBA 102, or ADC 97, are available. The reserve account component 418 obtains the available funds and transfers it to the reserve account 324 maintained at DIB 114. To perform the transfer funds from the deposited location, such as FI 320 to the reserve account 324, the payment processor 112 (“PP 112”), in one embodiment, via an ACH network, settles the transaction. The reserve accounts 324 and 328 are “connected” via the FX broker 320 who converts the finds from reserve account 324 and deposits the converted amount to the reserve account 328 via payment processor 112 and 116. The FX broker 320 process such currency conversion according to the instructions provided by SL 110 or OPS 310.

When a recipient makes a payment (or withdraw finds) from the withdraw account maintained in FIB 118, an authorization and settlement request is sent to the PP 116 from the financial institution that made a sale or provided funds (i.e. ATM, POS, Bank) to the recipient. Upon settlement, the payment processor 116 draws funds from the reserve account 328 to pay for any authorized withdraw related to the withdraw account located at the FIB 118.

The OPS 310 has a blocking component 416 which prevents any withdraw or payment from the deposit accounts, i.e. DBA 102, AC 104, DAC 206, DAN 204, ADC 97. The blocking component 416 can limit the accounts to deposits only through a variety of suitable means such as embedding the account with an over limit notice or an insufficient funds notice. The blocking can also be accomplished in conjunction with a financial network by designating the deposit account and/or card as a deposit only account through the assignment of a unique ID number. For example all deposit accounts can start with “00”.

The OPS 310 has a computational component 418 for calculating a variety of factors including: currency and price conversions, transaction charges, interest rates and commissions for Agent 302 and other transaction factors. The deposited amount in DBA 102 is passed through the computational component 418 which computes the amount to be credited to WBA 106. The OPS 310 has a dispatch component 420 for routing and dispatching credit to the withdraw account, i.e. WBA 106 or AWC 95. The OPS 310 has a transaction data component 422 which logs all transactions. The customer, Agent 302 or SL 110 can log onto website 306 and view a detailed log of any related transactions.

### Example 1

### Paired Bank Accounts

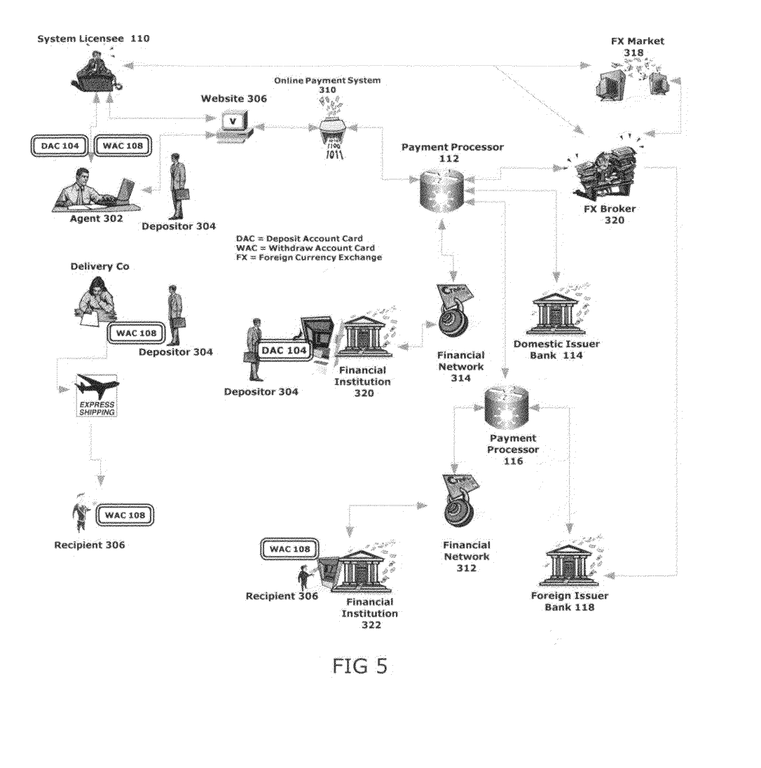

Referring to FIG. 5, a depositor 304 (“Depositor 304”), based in Canada, is issued a DBA 102 and WBA 106 by SL 110 via an Agent 302. Depositor 304 sends recipient 306 (“Recipient 306”), based in Mexico, AC 206 via a deliver company. The PIN for AC 206 can be provided to Recipient 306 through a variety of suitable means such as phone, fax, email etc. Depositor 304 uses AC 104 to deposit a check at an ATM machine of financial institution 320 (“FI 320”).

FI 320 sends the transaction detail to the financial network 314 which transfers the transaction detail to a payment processor 112 connected to OPS 310. Based on the deposit information, the verification component 410 of OPS 310 determines that the method of deposit is a check via an ATM machine. The verification component 410 proceeds to scan DBA 102 for funds availability (e.g. once a day) until the funds are available, if at all (i.e. bad check). Verification component 410 updates the system or cancels the transaction as applicable.

When the funds are available, the FX 412 component of OPS 310 contains the latest FX rates and conversion formula, and in one embodiment, is updated by SL 110, and/or FX broker 320 and/or FX market system 318. Based on such information the FX 414 component determines the current exchange rate between the DBA 102 currency and WBA 106 currency. In another aspect, the FX 414 component sends a request for currency exchange to the FX broker 320 automatically for each transaction.

The reserve account component 418, based on information from verification component 410, draws all available funds from DBA 102 and transfers the funds to a reserve account 324. The computational component 420 applies any applicable foreign currency exchange rates, transactions charges, interest rates, commissions for Agent 302 etc, against the deposited amount.

The funds are now transferred from reserve account 324 to reserve account 328. The FX broker 320 receives a first currency from reserve account 324 and deposits a second currency to reserve account 328. The dispatch component 422 sends a credit instruction via PP 112 through PP 116 to WBA 106 setting a credit limit for WBA 106. Recipient 306 using AC 206 makes a withdraw from financial institution 322 (“FI 322”). The financial network 312 (“FN 312”) recognizes the issuer bank and account ID of AC 206, allowing FI 322 to dispense cash to the Recipient 306. The funds are transferred from reserve account 328 to FI 322 responsive to an authorized payment request initiated by the recipient.

### Example 2

### Secure Account with Deposit Account ID and Withdraw Account ID

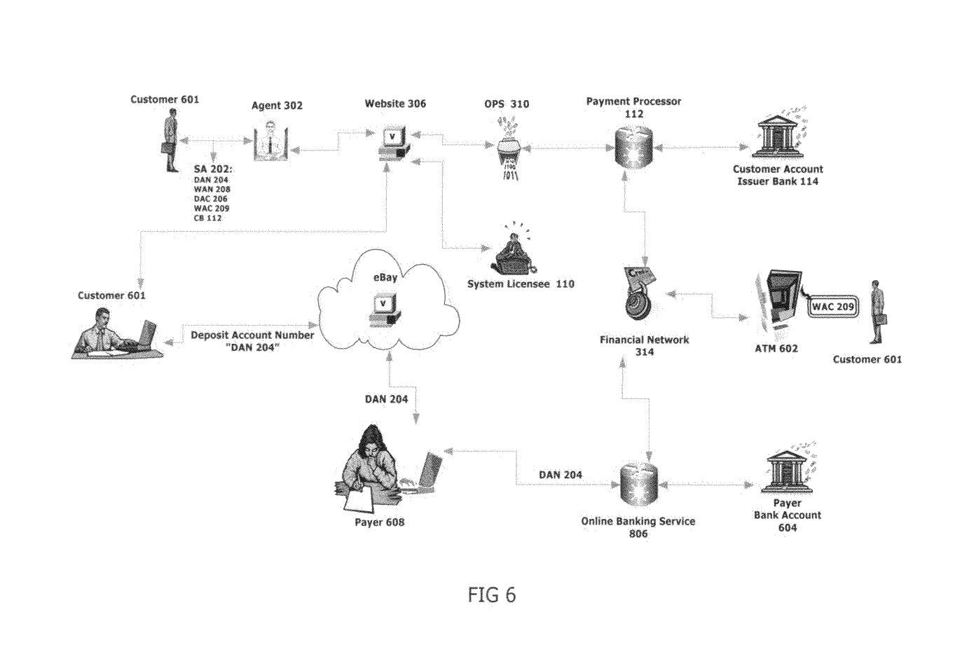

Referring to FIG. 6, Agent 302 on behalf of SL 110 issues a customer 601 a SA 202 similar to the issuing of accounts described in Example 1. Along with SA 202 customer 601 has a DAN 204, WAN 208, DAC 206, WAC 209 and CB 112. The DAC 206 has the PIN printed on the card, while WAC 209 has a confidential PIN known only to the customer 601.

In this example customer 601 sells an item to a buyer 608 (payer) through an online auction site such as eBay. The customer 601 communicates to the buyer 608 the DAN 204. Buyer 608 can pay customer 601 by using DAN 204 to make a deposit into SA 202. In one embodiment, the buyer 608 contacts her bank 604 via the bank's online banking service 606, and requests a transfer of funds from her bank account to the SA 202 of customer 601 using the DAN 204 to identify the bank account information of the customer 601.

Bank 604 via its payment processor and the FN 314, transfers the funds to the SA 202 of customer 601, which is held at issuer bank 114. The transaction is processed through PP 112 which is in communication with OPS 310 and SL 110. The customer 601 logs onto website 306 to verify that the payment is deposited into SA 202. Customer 601 sends the purchased product to the buyer 608. Upon verification of the deposit, the OPS 310 sends a credit instruction to WAN 208 establishing a credit limit for withdraws.

To access the funds in SA 202, customer 601 uses WAC 209 at ATM 602 to withdraw funds. ATM 602 which is connected to the financial network 314 recognizes the account issuer and account ID. The customer 601 enters in the PIN associated with WAC 209. The PP 112 and OPS 310 recognizes the WAC 206 and its PIN. An authorization request is relayed to SA 202. Since SA 202 has sufficient finds, the PP 112 approves the authorization request. The ATM 602 dispenses the funds to customer 601. The funds are transferred from SA 202 to the financial institution maintaining ATM 602 (not shown) responsive to an authorized payment request initiated by the recipient.

### Example 3

### Deposit Card Account and Withdraw Card Account

A customer purchases ADC 97 and AWC 95 from a retail store authorized to sell the account cards. The cards have an account ID and PIN, and come activated and ready to use. The customer sends the AWC 95 to the recipient and deposits funds at an ATM using ADC 97. As described in the two previous examples, the system and methods described herein transfers the funds from ADC 97 at a first location to AWC 95 at a second location. Upon verification of the deposit, the OPS 310 sends a credit instruction to AWC 95 establishing a credit limit for withdraws. The recipient can use AWC 95 to make purchases and withdraws as with a debit or prepaid credit card as with the above examples.

Because ADC 97 and AWC 95 are issued anonymously, certain government regulations apply. For example some countries limit the anonymous transfer of finds to $300 per week. In one aspect, transfers above the legal limit will result in cancellation of the cards.

### CONCLUSION

Other variations, applications and ramifications of the present invention will occur to those skilled in the art upon reading this disclosure. Those are intended to be included within the scope of this invention, as defined in the appended claims. For example the OPS 310 can be modified to account for implementation of specific embodiments discussed herein. In one example, the system and methods of the disclosure are applicable for domestic to domestic (i.e., Canada to Canada) transfers as well. In this embodiment, OPS 310 can function without a foreign currency exchange rate component.

What is claimed is:

1. A computer implemented method of transferring funds from a depositor to a recipient comprises:
at least one account issuer issuing a deposit account with an account identification number;
at least one account issuer issuing a withdraw account with an account identification number;
wherein said deposit account has a deposit account card with a personal identification number and a deposit account card identification number;
wherein said withdraw account has a withdraw account card with a personal identification number and withdraw account card identification number;
providing the recipient with said withdraw account card;
providing said depositor with said deposit account card;
the depositor depositing funds into said deposit account;
wherein the method of deposit is selected from the group consisting of automated teller machine (“ATM”), financial institution, and internet banking;
said online processing system receiving transaction details of said deposit;
said online processing system blocking any withdraw of funds from said deposit account;
said online processing system determining the method of deposit;
said online processing system detecting when the funds in the deposit account are available for withdraw;
said online processing system deducting applicable fees from said deposited funds; wherein
said fees are selected from the group consisting of foreign currency rate fees, service fees, transaction fees, foreign currency exchange fees, agent commission fees, processing fee, government fees and maintenance fee;
said online processing system processing any transfer restrictions;
said online processing system sending a credit instruction to the withdraw account responsive to the available funds in said deposit account;
wherein the recipient may use said withdraw access account card as a prepaid credit or debit card to obtain cash, services and goods; and
said online processing system receiving transaction details of said withdraw.

2. The method of claim 1 further comprising said deposit account is maintained in a domestic currency located at a first financial institution;
wherein said withdraw account is maintained in a foreign currency located at a second financial institution;
exchanging the currency between said deposit account and said withdraw account; and
said online processing system applying automatically up to date foreign currency exchange rates.

3. The method of claim 1 wherein said deposit and withdraw accounts are a single secure account issued by a single financial institution;
wherein said secure account has a deposit account identification number; and
wherein said withdraw account has a withdraw account identification number.

4. The method of claim 3 further comprising responsive to an authorized payment request initiated by the recipient, transferring at least a portion of the funds from said withdraw account to the recipient.

5. The method of claim 2 further comprising transferring funds from said deposit account to a first reserve account located at said first financial institution; and
transferring funds from said first reserve account to a second reserve account located at said second financial institution; and
transferring at least a portion of the funds from said second reserve account to the recipient, responsive to an authorized payment request initiated by the recipient.

6. The method of claim 1 wherein said deposit account is a card account having a card identification number and a personal identification number;
wherein said withdraw account is a card account having a card identification number and a personal identification number; and
wherein said deposit account identification number, deposit card identification number and personal identification number is not confidential.

7. The method of claim 6 further comprising transferring at least a portion of the funds from said withdraw account to the recipient, responsive to an authorized payment request initiated by the recipient.

8. The method of claim 7 wherein said deposit and withdraw account is issued to an anonymous depositor or recipient.

9. The method of claim 1 wherein said deposit account identification number, deposit card identification number and personal identification number for said deposit account are not confidential.

10. The method of claim 1 further comprises linking a plurality of withdraw cards to said deposit account; and
wherein each withdraw card has a unique personal identification number.

11. The method of claim 1 further comprises linking a plurality of deposit cards to said withdraw account.

12. A computer-readable medium storing instructions which, when executed by a processor, cause a system to perform a method for executing a financial transaction, the method comprising: at least one account issuer issuing a deposit account with an account identification number;
at least one account issuer issuing a withdraw account with an account identification number;
wherein said deposit account has a deposit account card with a personal identification number and a deposit account card identification number;
wherein said withdraw account has a withdraw account card with a personal identification number and withdraw account card identification number;
providing the recipient with said withdraw account card;
the depositor depositing funds into said deposit account;
wherein the method of deposit is selected from the group consisting of automated teller machine, financial institution, and internet banking;
an online processing system receiving transaction details of said deposit;
said online processing system determining the method of deposit;
said online processing system detecting when the funds in the deposit account are available for withdraw;
said online processing system blocking any withdraw of funds from said deposit account;
said online processing system deducting applicable fees from said deposited funds; wherein
said fees are selected from the group consisting of foreign currency rate fees, service fees, transaction fees, foreign currency exchange fees, agent commission fees, processing fee, government fees and maintenance fee;
said online processing system sending a credit instruction to the withdraw account responsive to the available funds in said deposit account;
said online processing system processing any transfer restrictions; and
wherein the recipient may use said withdraw access account card as a prepaid credit or debit card to obtain cash, services and goods.

13. The method of claim 12 further comprising said deposit account is maintained in a domestic currency located at a first financial institution;
wherein said withdraw account is maintained in a foreign currency located at a second financial institution;
wherein said deposit account identification number, deposit card identification number and personal identification number is not confidential;
exchanging the currency between said deposit account and said withdraw account;
said online processing system applying automatically up to date foreign currency exchange rates;
transferring funds from said deposit account to a first reserve account located at said first financial institution;
transferring funds from said first reserve account to a second reserve account located at said second financial institution; and
transferring at least a portion of the funds from said second reserve account to the recipient, responsive to an authorized payment request initiated by the recipient.

14. The method of claim 12 further comprising said deposit and withdraw accounts are a single secure account issued by a single financial institution;
deposit account identification number;
wherein said withdraw account has a withdraw account identification number;
wherein said deposit account identification number, deposit card identification number and personal identification number is not confidential; and
responsive to an authorized payment request initiated by the recipient, transferring at least a portion of the funds from said withdraw account to the recipient.

15. The method of claim 12 wherein said deposit account is a card account having a card identification number and a personal identification number;
wherein said withdraw account is a card account having a card identification number and a personal identification number;
wherein said deposit card identification number and personal identification number is not confidential;
wherein said deposit and withdraw account is issued to an anonymous depositor or recipient; and
transferring at least a portion of the funds from said withdraw account to the recipient, responsive to an authorized payment request initiated by the recipient.

16. An apparatus for transferring money from a depositor to a recipient comprises:
an account activation component operative to register the account holder;
a database component operative to maintain a database of issued linked deposit and withdraw accounts, cards and currencies;
a verification component operative to determine when funds are available said in deposit accounts;
a memory component operative for storing historical transaction information;
a calculator component operative to deduct appropriate fees from the deposited funds;
a communication interface component operative to communicate with at least one communication network;
a foreign currency exchange component operative to maintain the current foreign currency exchange rate;
a reserve account component operative of transferring funds from a deposit account to a reserve account;
a blocking component operative to prevent withdraws from said deposit account; and
a dispatch component operative for routing and dispatching credit limit for withdraw account.

17. The apparatus of claim 16 wherein said database component further maintains a database of information selected from the group consisting of accountholder identification number, deposit account identification number, withdraw account identification number, card identification number, deposit card personal identification number, withdraw card personal identification number, origination currency, destination currency, agent identification number, agent commission, transaction restriction, transaction settlement agreement terms, foreign currency rates, service fees, historic transactions, settlements and authorized transactions, transaction fees, foreign currency exchange fees, agent commission fees, processing fees, government fees, and a maintenance fee.

18. The apparatus of claim 16 wherein said calculator component adjusts the deposit amount according to current foreign exchange rates for any international transfers.

19. The apparatus of claim 16 wherein said verification component determines the method of deposit.

20. The apparatus of claim 17, wherein an account activation component is operative to register the identity of the accountholder and the identity of the recipient; and
wherein said deposit card personal identification number is not confidential.
